(19) United States
(12) Patent Application Publication
(10) Pub. No.: US 2019/0203531 A1
(43) Pub. Date: Jul. 4, 2019

(54) BOXES FOR BLINDS

(71) Applicant: Pellini S.p.A., Codogno (LO) (IT)

(72) Inventors: Giovanni NICOLOSI, Dresano (MI) (IT); Alessandro PELLINI, Codogno (LO) (IT)

(21) Appl. No.: 16/333,960

(22) PCT Filed: Sep. 17, 2017
(86) PCT No.: PCT/IB2017/055650

§ 371 Date: Mar. 15, 2019

(30) Foreign Application Priority Data
Sep. 19, 2016 (IT) 102016000093933

(51) Int. Cl. E06B 9/323; E06B 9/322; E06B 9/303

(52) U.S. Cl. CPC E06B 9/323; E06B 9/303; E06B 9/322

(57) ABSTRACT

A box (1) for a closing system (4) comprises a box body (2) configured to accommodate a movement unit (3). The box body (2) is defined by a support profile (6) and by a closing profile (7) extending along a major extension direction (A); the box body (2) also having at least one upper wall (2a), a lower wall (2b), a connecting wall (2c) defined by the support profile (6); the box body (2) also having a closing wall (2d) defined by the closing profile (7); the closing profile (7) is fixable to the support profile (6), the lower wall (2b) has a plurality of slots (8) configured to each receive a respective support element (9) for a roller (3) of the blackout blind (4).

### FIELD OF APPLICATION OF THE INVENTION

The present invention relates to the sector of movable structures by means of which it is possible to mutually separate two areas, or it is possible to at least partially prevent the passage by light or persons through an opening in a wall separating two separate areas.

Among movable structures belonging to this type, by way of example, blind or shutter type closing systems are included.

Below, the expression “closing system” in the present description means all movable structures of the aforesaid type.

More specifically, the present invention relates to a box for a “closing system” of the type mentioned above.

Such box is usefully used in double panes intended for the thermal and light insulation of buildings, but it may also be used outside the double panes itself or the frame of a window.

### BACKGROUND ART

The use of a box for a “closing system” is known in the background art. Such box comprises a box body configured to accommodate the movement unit of the “closing system” such as for example, a Venetian blind or pleated blind.

In detail, the box body has a major extension direction, that is to say it has a shape which is elongated in such major extension direction. The box body has a parallelepiped shape and comprises a front wall, a rear wall, an inner wall and an outer wall. The upper wall is removable so as to allow the insertion of the roller, its supports and their movement members during assembly. Since such boxes are generally intended to be inserted in double panes which usually comprise a frame consisting of one or more spacer elements mounted on the sides of the chamber defined between two sheets of glass in order to keep the latter offset from each other and to prevent the leaking of gases along the edges. The spacer elements are connected to one another with convenient angular elements, or alternatively they may be obtained with a single element folded in the manner of a closed frame.

Such double panes therefore define a gap which transverse size is defined as the distance between the facing surfaces of two glass sheets. Therefore, the box must be selected on the basis of the size of the gap of the double panes itself.

Recently, interest is emerging in inserting, in existing double panes without a blackout blind, a “closing system”, such as for example a Venetian blind or pleated blind.

For economic reasons, it is preferable to perform such operation without having to replace doors and windows. This results in the “closing system” requiring measurements that are compatible with the ones of the existing double panes.

Disadvantageously, the double panes for which the “closing system” is to be inserted has an extremely limited useful gap for installation, and the box assembly system used to date does not allow the insertion of blind components for transverse sizes less than 20 mm.

Accordingly, it is disadvantageous to assemble known boxes in double panes having such size or smaller sizes, making it impossible to improve such double panes.

An example of boxes for such closing systems is described in documents of prior art BE501492, US 2014/305601, EP 2628884 and DE 20200701076801.

### SUMMARY OF THE INVENTION

In this context, the technical task at the basis of the present invention is to propose a box for a “closing system” which overcomes the above-mentioned drawbacks of the known technique.

In particular, it is the object of the present invention to make available a box for a “closing system” capable of being inserted in double panes of any size.

The technical task identified, and objects specified are substantially achieved by a box for a “closing system” comprising the technical features explained in one or more of the appended claims.

In particular, one embodiment of a box for a “closing system” according to the present invention comprises a box body configured to accommodate a movement unit of the “closing system”. The box body has a major extension direction and is defined by a support profile and by a closing profile extending along such major extension direction.

The box body has at least one upper wall, a lower wall, a connecting wall and a closing wall. The connecting, upper and lower walls are defined by the support profile. The closing wall is defined by the closing profile.

The closing profile is fixable to the support profile to close the box body. The lower wall has a plurality of slots configured to each receive a respective support element for the movement unit of the “closing system”.

Advantageously, opening the box at the closing wall, which is transverse with respect to the upper and lower walls, allows inserting the movement unit comprising among other things, a roller and/or at least one drum and relative ropes and/or ladders required to easily move the blind in the box, regardless of the transverse size of the box itself. It is therefore possible to make boxes of any size, even more narrow boxes than the ones known from the background art.

Optionally, when the closing profile is fixed to the support profile, the distance between the closing wall and the connecting wall is equal to or less than 20 mm.

Optionally, the box may comprise at least one support element for a roller of a blackout blind. Such support element has a base configured to abut on the lower wall of the box body. Such support element comprises a projection projecting from the base and configured to be inserted into the slot of the lower wall and to lock the sliding of the support element along the lower wall.

### LIST OF DRAWINGS

Further features and advantages of the present invention shall be more apparent from the indicative, and therefore non-limiting, description of a preferred, but not exclusive, embodiment of a box for a blackout blind, as illustrated in the accompanying drawings, in which:

FIG. 1 is a perspective view of a box for blackout blinds according to the present invention, in a first mounting step;

FIG. 1a is an enlarged view of a detail of the box in FIG. 1, in a first mounting step;

FIG. 2 is a perspective view of the box in FIG. 1, in a second mounting step;

FIG. 3 is a perspective view of the box in FIGS. 1 and 2, in a third mounting step;

FIGS. 3a and 3b are sectional views of the box in FIGS. 1 and 2, in the mounting step in FIG. 3; and

FIG. 4 is a perspective view of the box in FIGS. 1 and 2, in a fourth mounting step.

### DETAILED DESCRIPTION

With reference to the accompanying drawings, 1 indicates a box for a “closing system” 4 according to the present invention.

The system for opening and closing 4 a communication route between two separate areas comprises separation means 4a suitable for allowing, and respectively preventing, at least partially, the crossing of said route by light.

For example, the separation means 4A materialize in a blackout blind, a Venetian blind or a pleated blind.

The “closing system” 4 comprises a movement unit 3 for moving the separation means 4A between at least a first open position and a second position for closing or opening such route.

The box 1 comprises a box body 2 and in particular, the movement unit 3 is insertable into the box body 2 of the box 1.

According to a preferred embodiment, the movement unit 3 comprises a roller and/or at least one drum, and also a plurality of ropes and/or ladders 5 which are active on the separation means 4A and rolling onto the roller and/or drum for moving the separation means 4A themselves.

In particular, the box body 2 has a major extension direction “A”. In other words, the box body 2 has a size along the major extension axis “A” which is much greater than the sizes in the plane perpendicular to the major extension direction “A”. In other words again, the box body 2 has an elongated shape in the major extension direction “A”. The box body 2 has substantially the shape of a parallelepiped extended along the major extension direction “A”.

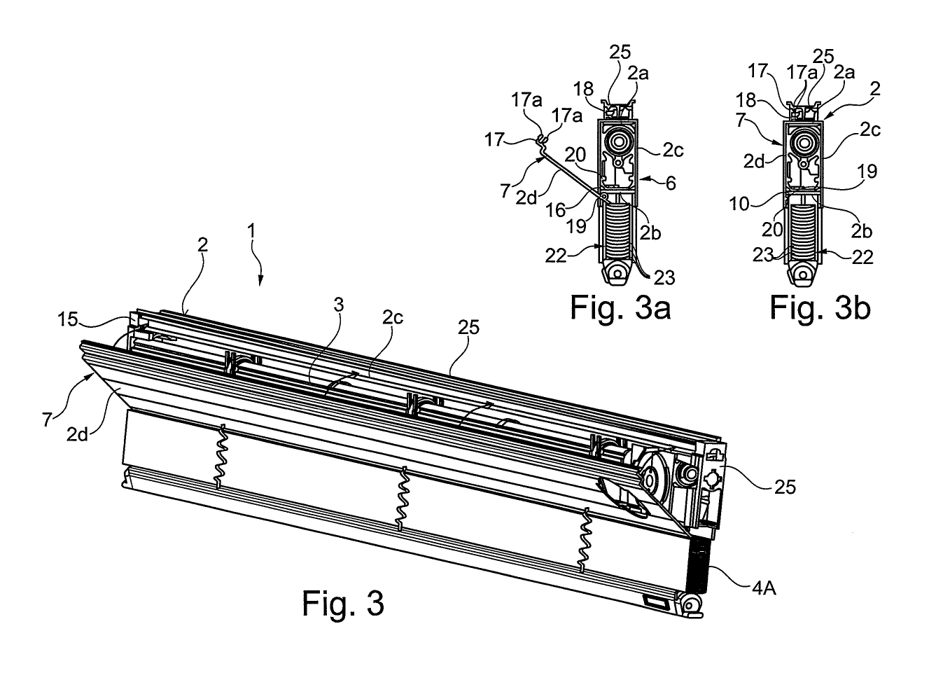

In greater detail, the box body 2 is defined by a support profile 6 and by a closing profile 7. Such profiles 6, 7 extend mainly along the major extension direction “A” of the box body 2. As shown in particular in FIG. 3, the closing profile 7 is fixable, that is in removable manner, to the support profile 6 to close the box body 2.

The profiles 6, 7 have a constant section along the major extension direction “A”.

Moreover, the profiles 6, 7 may be made of aluminium.

According to an advantageous embodiment of the invention, the support profile 6 and/or the closing profile 7 are made of PVC or a combination of aluminium and PVC. Thereby, it is avoided to make heat bridges in the case in which the box comes into contact when in use, with the surfaces of glass or of the frame of the double panes, so as to simplify the use of the box 1 in a thermally insulating double panes.

The box body 2 also comprises at least one upper wall 2a, a lower wall 2b, a connecting wall 2c and a closing wall 2d. In detail, the connecting 2c, upper 2a and lower 2b walls are defined by the support profile 6. In other words, the connecting 2c, upper 2a and lower 2b walls are integrally made with the support profile.

The closing wall 2d is defined by the closing profile 7.

Moreover, the lower wall 2b has a contact edge 16 configured to abut on the closing wall 2d during mounting.

According to a particularly advantageous embodiment of the invention, when the closing profile 7 is fixed to the support profile 6, that is to say when the box 1 is assembled, the distance between the closing wall 2d and the connecting wall 2c is equal to or less than 20 mm.

It is however worth noting that in alternative embodiments of the invention, the distance between the closing wall 2d and the connecting wall 2c may be any distance. Greater details on the walls 2a, 2b, 2c, 2d and on the assembly of the box body 2 will be provided in a later part of the present description.

A pair of plugs 15, arranged transversely and preferably perpendicularly with respect to the major extension direction “A”, close the box body 2 at the two opposite ends of the profiles 6, 7. Such plugs 15 have a portion which is insertable into the box body 2 and are each provided with a respective engagement member (not illustrated) which is insertable into a further slot 27 of the lower wall 2b of the box body 2 to lock the plug 15 into the seat.

The box 1 comprises also at least one support element 9 for the above-mentioned movement unit 3. Such support element 9 has a base 10 configured to abut on the lower wall 2b of the box body 2. A pair of uprights 11 extends from the base 10 and they define a seat 12 in which there is inserted a bushing 13 which, in use, surrounds the roller or the drum of the movement unit 3 and rotates integrally therewith inside the seat 12.

The support element 9 further comprises a projection 14 projecting from the base 10, in particular in direction which is opposite to the uprights 11.

The support element 9 has an opening 21 at the base 10, and in particular at the projection 14. Such an opening serves the function of allowing the passage of one or more ropes and/or ladders 5 of the blind 4A from the outside of the box body 2 towards the inside of it.

The lower wall 2b of the box body 2 has a plurality of slots 8 for receiving the support elements 9. Such slots 8 are conveniently distributed along the major extension direction “A”. Such slots 8 are configured to each receive a respective support element 9 for the roller 3. In particular, the projection 14 of each support element 9 is configured to be inserted into the slot 8 and to lock the sliding of the support element 9 along the lower wall 2b. It is worth noting that the above-mentioned opening 21 is, in use, at the respective slot 8.

The box 1 comprises a plurality of support elements 9, in particular it comprises a number of support elements 9 equal to the number of slots 8.

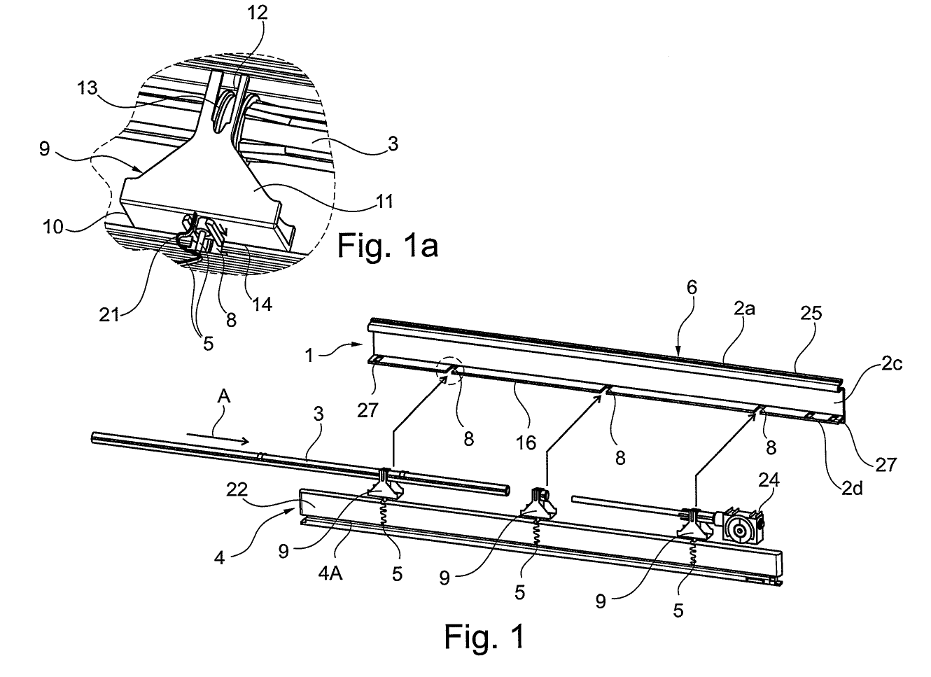

It is worth noting that the above-mentioned contact edge 16 is discontinuous at the slots 8. In other words, the slots 8 are open at the contact edge 16 so as to allow the insertion of the projection 14 as shown for example, in FIG. 1a.

With reference in particular to FIGS. 3a and 3b, the closing wall 2d has an engagement edge 17. The upper wall 2a at least partly defines a receiving seat 18 for such engagement edge 17. The engagement edge 17 is insertable into the seat 18 to engage the upper wall 2a to the closing wall 2d.

Preferably, such engagement is obtained by means of an elastic bending of hooks 17a which extend from the engagement edge 17 transversely with respect to the closing wall 2d, in particular in direction of the upper wall 2a. In other words, the hooks 17a obtain a snap-in type joining between the closing wall 2d and the upper wall 2a.

The closing wall 2d also has an engagement edge 19, in particular opposite to the above-described engagement edge 17. Such engagement edge 19 is configured to engage a projecting portion 20 of the lower wall 2b.

The box 1 may optionally comprise a grip portion 25 fixed to the upper wall 2a and configured to be engaged by an upper element 26 which in turn can be associated for example, with a frame of a double panes (not illustrated). Such grip portion 25 is in particular integrally made with the upper wall 2a, that is to say it is part of the support profile 6 of the box 1. Such grip portion 25 acts in conjunction with the upper wall 2a to define the above-mentioned seat 18 for the engagement edge 17. In detail, such grip portion has a transverse “T-shaped” section, where the upper portion is arranged substantially parallel to the upper wall 2a.

It is worth noting that since the grip portion 25 is integrally made with the upper wall 2a, it also ensures the complete closing of the box 1 so as to protect the components accommodated in the box from impurities and dirt. Such advantage can obviously be verified should the box be installed outside the double panes.

The aforesaid feature according to which the grip portion 25 is integrally made with the upper wall 2a facilitates also the fastening of the box to the support of the double panes in a more secure and easier manner.

The assembly of the box 1 with the closing system 4 occurs in the following manner.

Firstly, the blind 4A is assembled in closed configuration. In the case illustrated, reference is made to a Venetian blind comprising a blackout element 22 defined by a plurality of blades 23 tied to one another by ropes and ladders 5, in a per se known manner and therefore not described.

With reference to FIG. 1, the ropes 5 are wound onto the roller and drums 13 or optionally, onto drums 13 alone. The roller is inserted into the drums 13 of the support elements 9.

At this point, the blind 4A has been assembled outside the box.

Then, the support elements 9 and the relative components associated therewith (blind 4A, roller, drums, ropes, ladders, etc.) are positioned on the support profile 6 of the box, in particular by inserting the projections 14 into the respective slots 8 made on the lower wall 2b.

Possible movement means 24, for example with magnetic mating, are then connected to the roller in a manner which in a per se known manner.

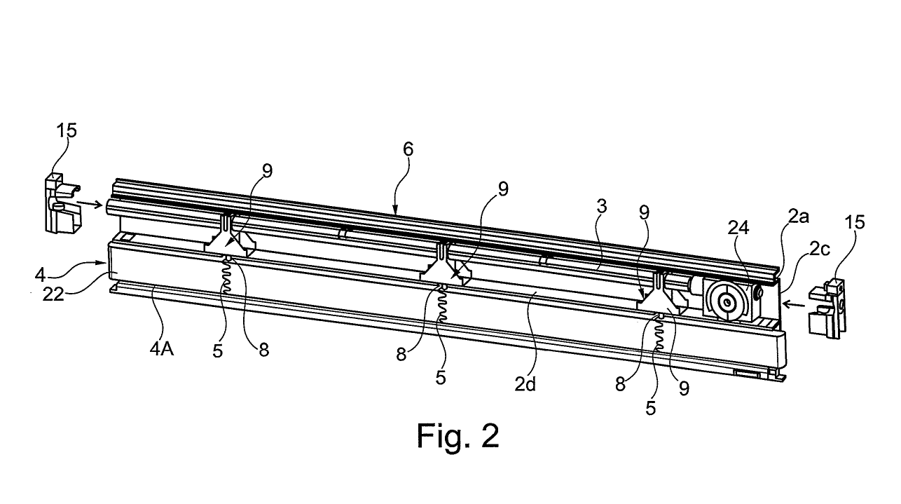

The end plugs 15 are then positioned, as shown in FIG. 2. Such plugs 15 are locked to the lower wall 2b of the box body 2 to provide support to the movement unit itself.

At this point, the closing system 4 is inserted into the volume defined by the box.

Then, in reference to FIGS. 3 and 3a, the closing profile 7 is fixed to the support profile 6 so as to encapsulate the closing system 4.

In detail, the engagement edge 19 of the closing wall 2d comes into contact with the lower wall 2b, in particular by engaging the projecting portion 20 of the lower wall 2b. The closing wall 2d is therefore caused to rotate as illustrated in FIG. 3a and by exerting a slight pressure sufficient to slightly bend the hooks 17a, the engagement edge is snap-locked in seat 18 made at the upper wall 2a.

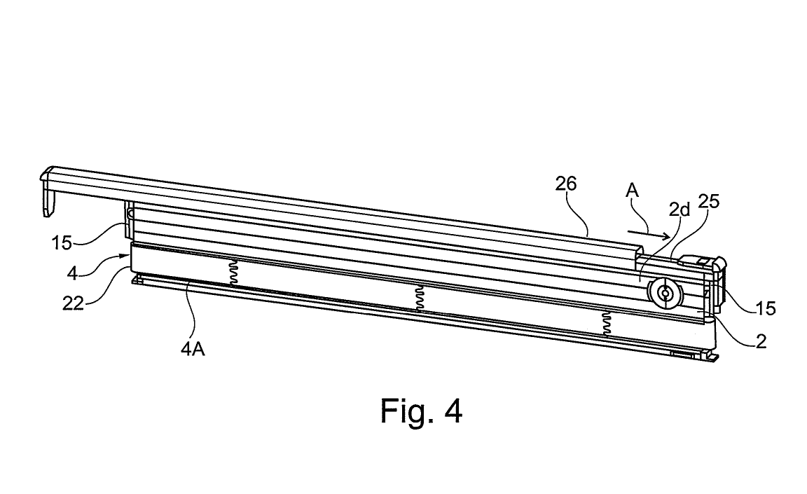

Optionally as shown in FIG. 4, in a successive step, the upper element 26 of the double panes may be inserted into the grip portion 25.

The box 1 and the movement unit 4 are ready for a possible insertion into the gap of a double panes.

Obviously, in order to meet contingent and specific needs, those skilled in the art may make several modifications to the box for a system for opening and closing a communication route between two separate areas described above, all however contained within the scope of protection as defined by the following claims.

1. Box for a system for opening and closing a communication route between two separate areas, said system comprising separation means suitable for allowing and preventing, respectively, at least partially, the crossing of said route by light, said box comprising a box body configured to accommodate a movement unit of said opening and closing system, said box body having a major extension direction and being defined by a support profile and by a closing profile extending along said major extension direction, said box body also having at least one upper wall, a lower wall, a connecting wall and a closing wall; said connecting wall, upper wall and lower wall are defined by said support profile, said closing wall being defined by said closing profile, said closing profile being removably fixable to said support profile for closing said box body, said lower wall having a plurality of slots, a support element for said movement unit; each slot of said plurality of slots being configured to receive one said support element;
wherein when the closing profile is fixed to the support profile, the distance between said closing wall and said connecting wall is equal to or less than 20 mm.

2. Box according to claim 1, characterized in that said lower wall has a contact edge configured to abut on said closing wall, said contact edge being discontinuous at said slots.

3. Box according to claim 1, wherein said closing wall has an engagement edge, said upper wall defining at least partially a receiving seat for said engagement edge, said engagement edge being insertable in said seat for engaging said upper wall to said closing wall.

4. Box according to claim 1, wherein said lower wall has a projecting portion, said closing wall having an engagement edge configured to engage said projecting portion.

5. Box according to claim 1, wherein said support profile and/or the closing profile are made of PVC.

6. Box according to claim 1, wherein said support element has a base configured to abut on said lower wall.

7. Box according to claim 6, wherein said support element comprises a projection projecting from said base and configured to be inserted in said slot and lock the sliding of said support element along said lower wall.

8. Box according to claim 6, wherein said support element has an opening at said base and at said slot, said opening being configured to allow the passage of at least one rope of said opening and closing system.

9. Box according to claim 1, characterized in that it comprises a grip portion fixed to said upper wall and configured to be engaged by an upper element for mating with the frame of a window or of a double pane.

10. A combination comprising:
a box having a major extension direction and being defined by a support profile and by a closing profile extending along said major extension direction, said box body also having at least one upper wall, a lower wall, a connecting wall and a closing wall; said connecting wall, upper wall and lower wall are defined by said support profile, said closing wall being defined by said closing profile, said closing profile being removably fixable to said support profile for closing said box body, said lower wall having a plurality of slots, a support element for said movement unit; each slot of said plurality of slots being configured to receive one said support element; when the closing profile is fixed to the support profile, the distance between said closing wall and said connecting wall is equal to or less than 20 mm;
a system for opening and closing a communication route between two separate areas, said system comprising separation means suitable for allowing and preventing, respectively, at least partially, the crossing of said route by light, a movement unit of said separation means between at least a first open position and a second closed position of said route, said movement unit insertable in the box body of said box and comprising a roller and/or at least one drum; a plurality of ropes and/or ladders being active on said separation means and rolling on said roller and/or at least one drum.
